(19) United States
(12) Patent Application Publication
(10) Pub. No.: US 2013/0155189 A1
(43) Pub. Date: Jun. 20, 2013

(54) OBJECT MEASURING APPARATUS AND METHOD

(71) Applicant: I-Thun LIN, Tu-Cheng (TW)

(72) Inventor: I-Thun LIN, Tu-Cheng (TW)

(73) Assignee: HON HAI PRECISION INDUSTRY CO., LTD., Tu-Cheng (TW)

(21) Appl. No.: 13/337,310

(22) Filed: Dec. 27, 2011

(30) Foreign Application Priority Data
Dec. 15, 2011 (TW) 100146653

(51) Int. Cl. H04N 13/02

(52) U.S. Cl. 348/46; 348/E13.074

(57) ABSTRACT

An exemplary object measuring method includes changing a focal length of a zoom lens in response to a user operation and taking images. The method then displays the images or one of them, determines a selected area, and defines the selected area as representing a object in the image. The method further determines virtual X and Y coordinate differences between a center point of an image and the object in the image. Next, the method calculates the actual differences between the testing device and the object. The method then controls the driving unit to drive the testing device to move a determined distance in an X direction and to move a determined distance in a Y direction.

### BACKGROUND

1. Technical Field

The present disclosure relates to object measuring to an object measuring apparatus and object measuring method.

2.Description of Related Art

An object measuring apparatus such as a coordinate measuring machine includes a CCD lens to capture images of objects placed on a measuring platform. The size of one measuring platform is about 300 mm×300 mm, and the conventional CCD lens has a fixed focal length lens whose angle of view is about 10 mm×10 mm, the operator may need to move the CCD lens to find the object on the measuring platform, which costs the operator time and efforts.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a schematic view of an object measuring apparatus in accordance with an exemplary embodiment.

FIG. 2 is a block diagram of the object measuring apparatus of FIG. 1.

FIG. 3 is a block diagram of a processor of the object measuring apparatus of FIG. 1.

FIG. 4 is a schematic view illustrating how to determine the virtual abscissa difference and the virtual ordinate difference between a center of an image and a object.

FIG. 5 is a flowchart of an object measuring method in accordance with an exemplary embodiment.

### DETAILED DESCRIPTION

The embodiments of the present disclosure are described with reference to the drawings.

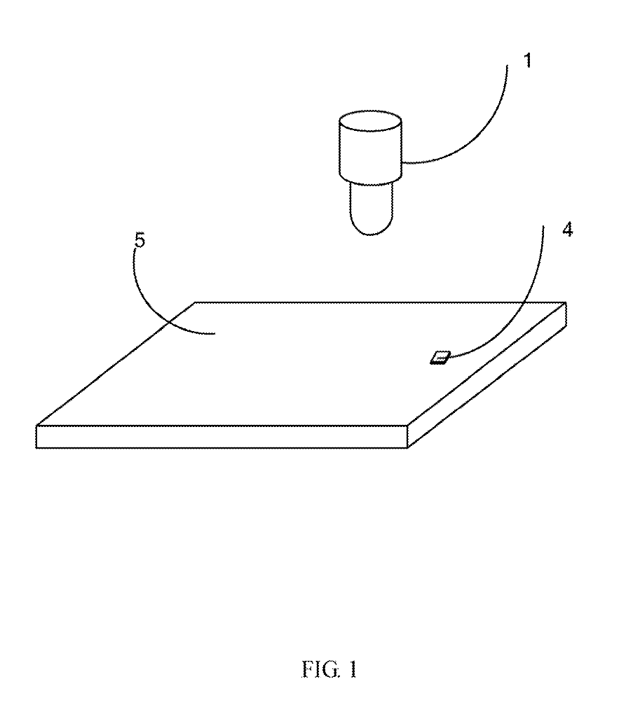

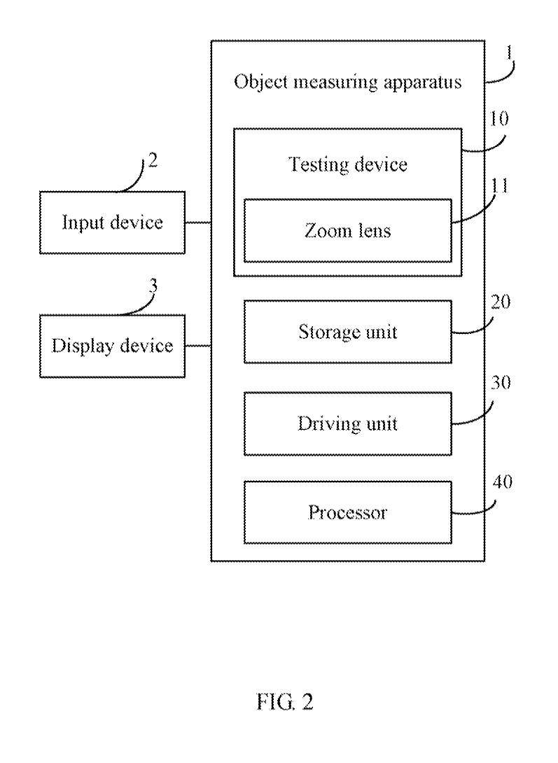

FIG. 1 shows a schematic view of an object measuring apparatus 1. In the embodiment, the object measuring apparatus 1 is 3D (3 dimensional) coordinate measuring machine. FIG. 1 shows a measuring head of the object measuring apparatus 1, other components such as a supporting member and a base are omitted. The object measuring apparatus 1 is connected to an input device 2 for user-input and to a display device 3 (see FIG. 2). The object measuring apparatus 1 is used to capture images of an object 4 which is placed on a measuring platform 5. The captured images are displayed on the display device 3.

Referring to FIG. 2, the object measuring apparatus 1 includes a testing device 10, a storage unit 20, a driving unit 30, and a processor 40. The testing device 10 includes a zoom lens 11 whose focal length can be varied. At different focal lengths, different images of the object 4 can be captured by the zoom lens 11. The storage unit 20 stores the ratios of the different image sizes of the object in the images captured by the zoom lens at various focal lengths to the real-life size of the object. The driving unit 30 is used to drive the testing device 10 to move.

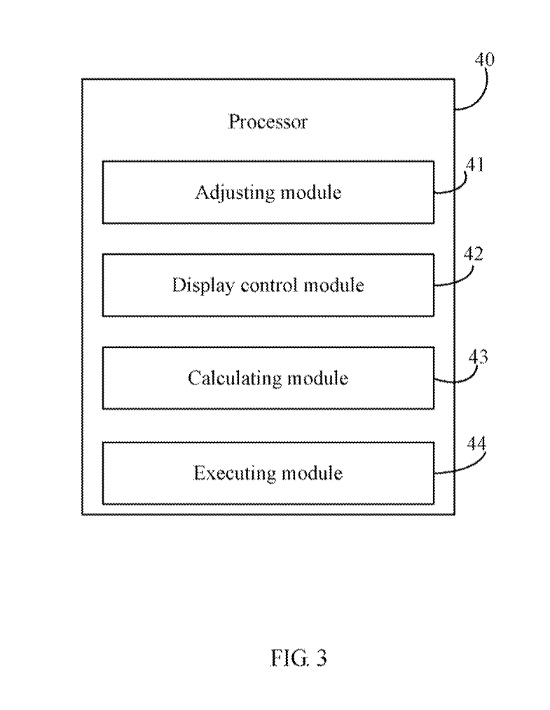

Referring to FIG. 3, the processor 40 includes an adjusting module 41, a display control module 42, a calculating module 43, and an executing module 44.

The adjusting module 41 is used to control the changes of the focal length of the zoom lens 11 in response to a user operation. A user can then adjust the focal length of the zoom lens 11 to take an image of the whole of the object 4.

The display control module 42 is used to control the display device 3 to display the images captured at varying focal lengths by the zoom lens 11. One area of the image displayed on the display device 3 can be selected by a user using the input device 2, such as a computer mouse.

The calculating module 43 is used to determine a selected area in response to a user operation of selecting an area in the image displayed on the display device 3, and define the selected area as representing the object 4 in the image. The calculating module 43 can further determine the actual two-dimensional differences (as applied to the relevant horizontal and vertical aspects of the object measuring apparatus 1) between the testing device 10 and the object 4.

In detail, the zoom lens 11 is set above the measuring platform 5, and the center point of a captured image is considered as a center of the projected area of the zoom lens 11 on the measuring platform 5. A two-dimensional Cartesian coordinate system is established and the center of the captured image is set to be the origin or zero point of the Cartesian coordinate system. The calculating module 43 determines a series of points of the contours of the object 4 in the captured image, and calculates a set of coordinates from a reference point, as a set of coordinates which can be applied to the object 4. The calculating module 43 determines the virtual horizontal or “X axis” difference and the virtual vertical or “Y axis” difference between the center point of the image and the object 4.

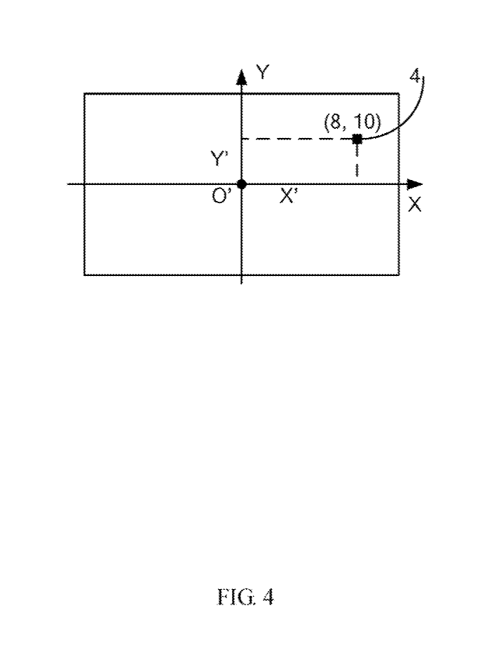

For example, in FIG. 4, in the image, the origin 0′ of the Cartesian coordinate system is the projected area of the zoom lens 11 on the platform 5, the X axis of the Cartesian coordinate system extends along the length of the platform, and the Y axis of the Cartesian coordinate system is across the width of the platform. The calculating module 43 determines that the set of the coordinates of the object 4 is (8, 10), based on a determination that the difference between X and X′, between the center of the image and the object 4, is 8, and that the difference between Y and Y′, between the origin and the object 4, is 10.

The calculating module 43 further calculates the actual differences in coordinates between the center of the zoom lens 11 and the object 4 according to the stored ratios of the image sizes of the object in the images captured at various focal lengths to the real-life size of the actual object, and the determined virtual abscissa difference and the determined virtual ordinate difference.

The executing module 44 is used to control the driving unit 30 to drive the testing device 10 to move a determined actual distance in the X or horizontal direction and to move a determined actual distance in the Y or vertical direction, thereby moving the lens 11 to a precise position above the object 4. The executing module 44 further varies the focal length of the zoom lens 11 to a predetermined focal length to take images of the object 4.

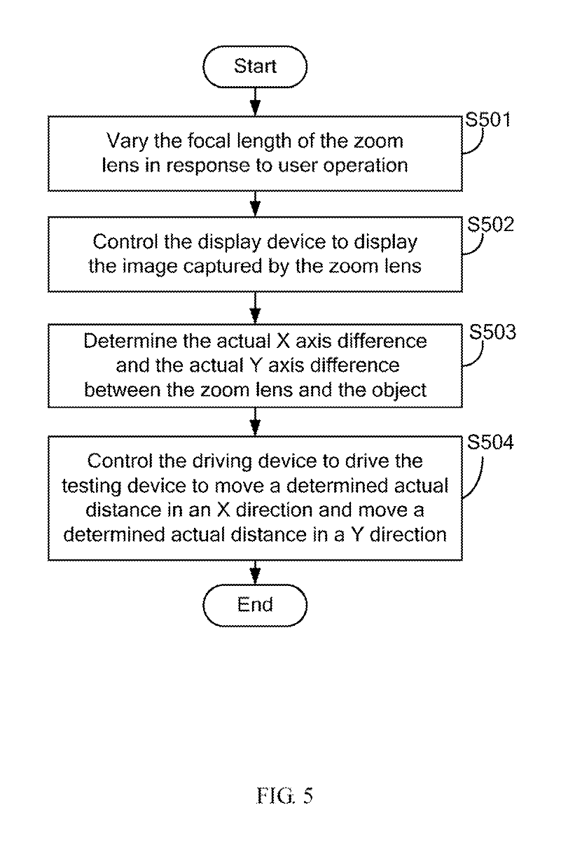

Referring to FIG. 5, a flowchart of an object measuring method is shown.

In step S501, the adjusting module 41 varies the focal length of the zoom lens 11 in response to the user operation, to allow the whole of the object 4 to be captured in one or more images.

In step S502, the display control module 42 controls the display device 3 to display the images captured by the zoom lens 11.

In step S503, the calculating module 43, in response to a user operation, determines a selected area in the image displayed on the display device 3, and defines the selected area in the image as representing the object 4. The calculating module 43 further determines the actual X axis and Y axis differences between the zoom lens 11 and the object 4. In detail, the center point of the captured image is considered as a center of the projected area of the zoom lens 11 on the measuring platform 5. On a Cartesian coordinate system, the center of the captured image is set as the origin or zero point of the Cartesian coordinate system. The calculating module 43 determines a series of points of the contours of the object 4 in the captured images, and calculates a set of coordinates from a reference point as the set of coordinates applying to the object 4. The calculating module 43 further determines the virtual X axis difference and the virtual Y axis difference between the center point of the image and the deemed center of the object 4, and further determines the actual X axis difference and the actual Y axis difference between the center of the zoom lens 11 and the object 4 according to the stored ratios of the image sizes of the object in images captured at various focal lengths to the real-life size of the actual object.

In step S504, the executing module 44 controls the driving unit 30 to drive the testing device 10 to move a determined distance in the X direction and to move a determined distance in the Y direction, and further varies the focal length of the zoom lens 11 to a predetermined focal length to take further images of the object 4.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An object measuring apparatus to measure an object placed on a measuring platform, comprising:
a testing device comprising a zoom lens whose focal length is variable;
a storage unit storing ratios of image sizes of the object in the images captured by the zoom lens at various focal lengths to a real-life size of the object;
a driving unit to drive the testing device to move;
an adjusting module to control the zoom lens to change the focal length thereof in response to a user operation;
a display control module to control a display device to display the image captured at varying focal lengths by the zoom lens;
a calculating module configured to:
determine a selected area in response to a user operation of selecting an area in the image displayed on the display device, and define the selected area as representing the object in the image;
determine a virtual horizontal or “X axis” difference and a virtual vertical or “Y axis” difference between a center point of an image captured by the zoom lens and the object in the image;
calculate an actual difference in horizontal or “X axis” and an actual difference in vertical or “Y axis” between the testing device and the object according to the stored ratios of the image sizes of the object in the images captured at various focal lengths to the real-lift size of the actual object, and the virtual abscissa difference and the virtual ordinate difference; and
an executing module to control the driving unit to drive the testing device to move a determined actual distance in a horizontal or X direction and to move a determined actual distance in a vertical or Y direction.

2. The object measuring apparatus as described in claim 1, wherein the calculating module further determines a series of points of the contours of the object in the captured image, and calculates a set of coordinates from a reference point as a set of coordinate which can be applied to the object, determines the center point of a captured image is considered as a center of the projected area of the zoom lens on the measuring platform, and further determines the virtual horizontal or “X axis” difference and the virtual vertical or “Y axis” difference between the center point of the image and the object.

3. The object measuring apparatus as described in claim 1, wherein the object measuring apparatus is a 3D coordinate measuring machine.

4. An object measuring method implemented by the object measuring apparatus of claim 1, the method comprising:
changing a focal length of the zoom lens in response to a user operation, to allow the whole of the object to be captured;
controlling a display device to display an image captured at varying focal lengths by the zoom lens;
determining the selected area in response to a user operation of selecting an area in the image displayed on the display device, and defining the selected area as representing the object in the image;
determining a virtual horizontal or “X axis” difference and a virtual vertical or “Y axis” difference between a center point of an image captured by the zoom lens and the object in the image;
calculating an actual difference in horizontal or “X axis” and an actual difference in vertical or “Y axis” between the testing device and the object according to the stored ratios of the image sizes of the object in the images captured at various focal lengths to the real-lift size of the actual object, and the virtual abscissa difference and the virtual ordinate difference; and
controlling the driving unit to drive the testing device to move a determined actual distance in a horizontal or X direction and to move a determined actual distance in a vertical or Y direction.

5. The object measuring method as described in claim 4, wherein the step of “determining the virtual horizontal or “X axis” difference and the virtual vertical or “Y axis” difference between a center point of an image captured by the zoom lens and the object in the image” comprises:
determining a series of points of the contours of the object in the captured image, and calculate a set of coordinates from a reference point as a set of coordinate which can be applied to the object in the image;
determining the center point of a captured image is considered as a center of the projected area of the zoom lens on the measuring platform; and
determining the virtual horizontal or “X axis” difference and the virtual vertical or “Y axis” difference between the center point of the image and the object.

6. The object measuring method as described in claim 4, wherein the object measuring apparatus is a 3D coordinate measuring machine.
